(19) United States
(12) Patent Application Publication
(10) Pub. No.: US 2026/0021846 A1
(43) Pub. Date: Jan. 22, 2026

(54) SYSTEM AND METHOD FOR TRAILER DIMENSION DETERMINATIONS

(71) Applicant: Continental Autonomous Mobility US, LLC, Auburn Hills, MI (US)

(72) Inventors: Malok Alamir Tamer, Troy, MI (US); Eduardo Jose Ramirez Llanos, Rochester, MI (US); Suraj Goyal, Rochester, MI (US)

(73) Assignee: Continental Autonomous Mobility US, LLC, Auburn Hills, MI (US)

(21) Appl. No.: 19/273,723

(22) Filed: Jul. 18, 2025

Related U.S. Application Data
(60) Provisional application No. 63/673,134, filed on Jul. 18, 2024.

(51) Int. Cl. B62D 13/06; G06T 7/13; G06T 7/73; G06V 10/44; G06V 10/74; G06V 20/56

(52) U.S. Cl. CPC B62D 13/06; G06T 7/13; G06T 7/73; G06V 10/44; G06V 10/761; G06V 20/56; G06T 2207/30252

(57) ABSTRACT

Visual trailer tracking for vehicle-trailer angle estimation is performed by: receiving image data from cameras positioned on a tow vehicle and rearwardly facing to capture a rearward environment of the tow vehicle that includes a connected trailer; detecting a representation of the trailer in the received image data from each of the cameras; based upon the trailer representation in the image data from each camera, selecting at least one camera from the plurality of cameras; detecting a feature of the trailer representation and a location of the trailer representation feature in the image data from the selected at least one camera; estimating a distance associated with the detected feature of the trailer representation; determining a trailer dimension based upon the estimated distance of the detected feature; and initiating a trailer-assist operation for the tow vehicle based upon the determined trailer dimension.

### TECHNICAL FIELD

This disclosure relates to a system and method for image-based vehicle dimension and trailer angle estimation for trailer forward or reverse assist operations.

### BACKGROUND

Trailers are usually unpowered vehicles that are pulled by a powered tow vehicle. A trailer may be a utility trailer, a popup camper, a travel trailer, livestock trailer, flatbed trailer, enclosed car hauler, and boat trailer, among others. The tow vehicle may be a car, a crossover, a truck, a van, a sports-utility-vehicle (SUV), a recreational vehicle (RV), or any other vehicle configured to attach to the trailer and pull the trailer. The trailer may be attached to a powered vehicle using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used.

Some of the challenges that face tow vehicle drivers is performing tow vehicle maneuvers while the trailer is attached to the tow vehicle. In some examples, more than one person may be needed to maneuver the tow vehicle towards the specific location. Since the vehicle-trailer unit swivels around the hitch horizontally allowing the vehicle-trailer unit to move around corners, when the vehicle moves, it pushed/pulls the trailer. Drivers are often confused as to which way to turn the vehicle steering wheel to get the desired change of direction of the trailer when backing up, for example. Applying an incorrect steering angle in the vehicle may also cause the trailer to jack-knife and lose its course. Some tow vehicles include a jack-knife detection function in which the tow vehicle detects the angle of the trailer relative to the tow vehicle surpassing a predetermined angle when travelling in reverse, and alerts the vehicle driver or autonomously maneuvers the tow vehicle in response so as to avoid a jack-knife situation from occurring.

Trailer assist systems often require accurate trailer characteristic information as system inputs, including various trailer dimensions and trailer position relative to the tow vehicle to which it is connected. By using only a tow vehicle's tailgate camera, or a camera in such a vicinity, such as the rear bumper or the rear of the vehicle, visibility of the trailer is limited to the front face of the trailer and is limited to a range of relatively lower trailer angles. Use of only such a tailgate camera limits the capability of visualizing the rear edges of the trailer, and, at higher trailer angles, it limits the capability to visualize front edges that are required for determining trailer dimensions and trailer angle.

It is thus desirable to provide a system that overcomes the challenges faced by drivers of tow vehicles attached to a trailer.

### BRIEF DESCRIPTION OF DRAWINGS

FIG. 1A is a schematic view of an exemplary tow vehicle hitched to a trailer.

FIG. 1B is a schematic view of an exemplary tow vehicle hitched to a trailer at a non-zero angle.

FIG. 2 is a schematic view of the exemplary tow vehicle having a trailer dimension calculating system, according to an example embodiment.

FIG. 3 is a flowchart illustrating the process for determining a trailer dimension and/or trailer angle, according to an example embodiment.

FIG. 4 is a flowchart illustrating a trailering operation that utilizes the trailer dimension determinations, according to an example embodiment.

FIG. 5 is a schematic view depicting stereo triangulation, by a tailgate camera and a side-view camera, of a corner of a trailer in accordance with one or more embodiments of the invention.

Like reference symbols in the various drawings indicate like elements.

### BRIEF SUMMARY

In accordance with embodiments of the invention, visual trailer tracking for vehicle-trailer angle estimation is performed by: receiving image data from cameras positioned on a tow vehicle and rearwardly facing to capture a rearward environment of the tow vehicle that includes a connected trailer; detecting a representation of the trailer in the received image data from each of the cameras; based upon the trailer representation in the image data from each camera, selecting at least one camera from the plurality of cameras; detecting a feature of the trailer representation and a location of the trailer representation feature in the image data from the selected at least one camera; estimating a distance associated with the detected feature of the trailer representation; determining a trailer dimension based upon the estimated distance of the detected feature; and initiating a trailer-assist operation for the tow vehicle based upon the determined trailer dimension.

### DETAILED DESCRIPTION

A tow vehicle, such as, but not limited to a car, a crossover, a truck, semi-tractor, a van, a sports-utility-vehicle (SUV), and a recreational vehicle (RV) may be configured to tow a trailer. The tow vehicle connects to the trailer by way of a vehicle coupler attached to a trailer hitch, e.g., a vehicle tow ball attached to a trailer hitch coupler. The trailer may be any type of trailer, including a fifth wheel trailer and a gooseneck trailer.

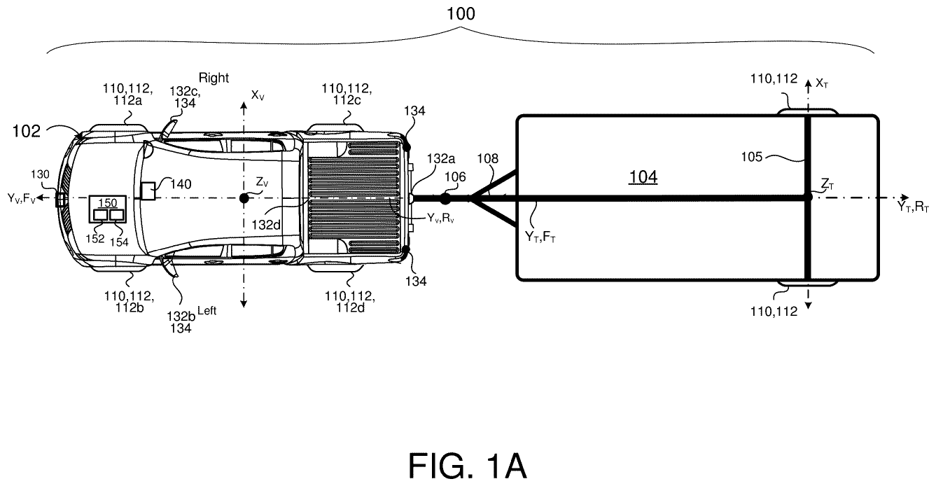

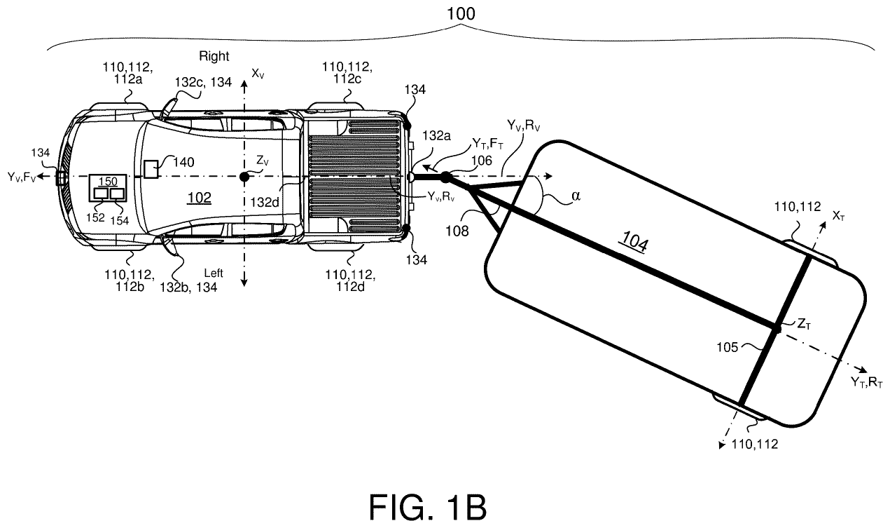

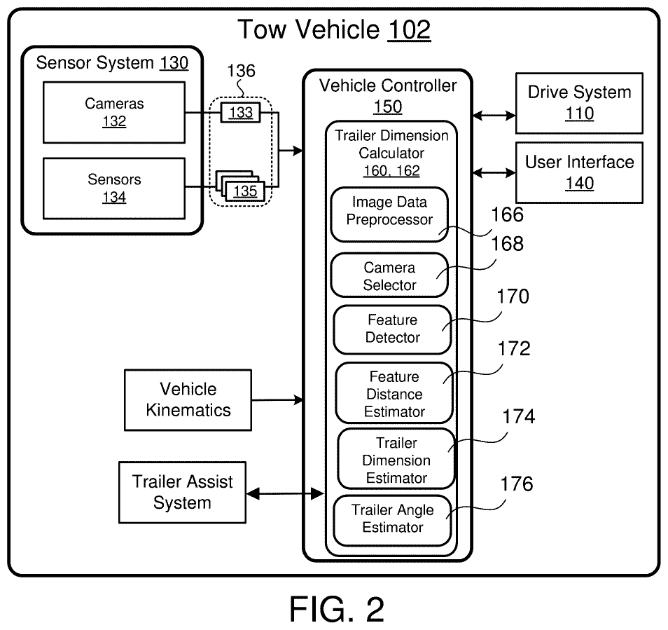

Referring to FIGS. 1A-2, in the disclosed implementations, a vehicle-trailer system 100 includes a tow vehicle 102 hitched to a trailer 104. In some implementations, the tow vehicle includes a vehicle tow ball attached to a trailer hitch coupler 106 supported by a trailer hitch bar 108 of the trailer 104. The tow vehicle 102 includes a drive system 110 associated with the tow vehicle 102 that maneuvers the tow vehicle 102 and thus the vehicle-trailer system 100 across a road surface based on drive maneuvers or commands having x, y, and z components, for example. The drive system 110 includes a front right wheel 112, 112a, a front left wheel 112, 112b, a rear right wheel 112, 112c, and a rear left wheel 112, 112d. In addition, the drive system 110 may include wheels (not shown) associated with the trailer 104. The drive system 110 may include other wheel configurations as well. The drive system 110 may include a motor or an engine that converts one form of energy into mechanical energy allowing the vehicle 102 to move. The drive system 110 includes other components (not shown) that are in communication with and connected to the wheels 112 and engine and that allow the vehicle 102 to move, thus moving the trailer 104 as well. The drive system 110 may also include a brake system (not shown) that includes brakes associated with each wheel 112, 112a-d, where each brake is associated with a wheel 112a-d and is configured to slow down or stop the wheel 112a-n from rotating. In some examples, the brake system is connected to one or more brakes supported by the trailer 104. The drive system 110 may also include an acceleration system (not shown) that is configured to adjust a speed of the tow vehicle 102 and thus the vehicle-trailer system 100, and a steering system (not shown) that is configured to adjust a direction of the tow vehicle 102 and thus the vehicle-trailer system 100. The vehicle-trailer system 100 may include other systems as well.

The tow vehicle 102 may move across the road surface by various combinations of movements relative to three mutually perpendicular axes defined by the tow vehicle 102: a transverse axis X_{V}, a fore-aft axis Y_{V}, and a central vertical axis Z_{V}. The transverse axis X_{V} extends between a right side R and a left side of the tow vehicle 102. A forward drive direction along the fore-aft axis Y_{V} is designated as F_{V}, also referred to as a forward motion. In addition, an aft or rearward drive direction along the fore-aft direction Y_{V} is designated as R_{V}, also referred to as rearward motion. In some examples, the tow vehicle 102 includes a suspension system (not shown), which when adjusted causes the tow vehicle 102 to tilt about the X_{V} axis and or the Y_{V} axis, or move along the central vertical axis Z_{V}. As the tow vehicle 102 moves, the trailer 104 follows along a path of the tow vehicle 102. Therefore, when the tow vehicle 102 makes a turn as it moves in the forward direction F_{V}, then the trailer 104 follows along. While turning, the tow vehicle 102 and the trailer 104 form a trailer angle α.

Moreover, the trailer 104 follows the tow vehicle 102 across the road surface by various combinations of movements relative to three mutually perpendicular axes defined by the trailer 104: a trailer transverse axis X_{T}, a trailer fore-aft axis Y_{T}, and a trailer central vertical axis Z_{T}. The trailer transverse axis X_{T} extends between a right side and a left side of the trailer 104 along a trailer turning axle 105. In some examples, the trailer 104 includes a front axle (not shown) and rear axle 105. In this case, the trailer transverse axis X_{T} extends between a right side and a left side of the trailer 104 along a midpoint of the front and rear axle (i.e., a virtual turning axle). A forward drive direction along the trailer fore-aft axis Y_{T} is designated as F_{T}, also referred to as a forward motion. In addition, a trailer aft or rearward drive direction along the fore-aft direction Y_{T} is designated as R_{T}, also referred to as rearward motion. Therefore, movement of the vehicle-trailer system 100 includes movement of the tow vehicle 102 along its transverse axis X_{V}, fore-aft axis Y_{V}, and central vertical axis Z_{V}, and movement of the trailer 104 along its trailer transverse axis X_{T}, trailer fore-aft axis Y_{T}, and trailer central vertical axis Z_{T}. Therefore, when the tow vehicle 102 makes a turn as it moves in the forward direction F_{V}, then the trailer 104 follows along. While turning, the tow vehicle 102 and the trailer 104 form the trailer angle α being an angle between the vehicle fore-aft axis Y_{V} and the trailer fore-aft axis Y_{T}.

The vehicle 102 includes a sensor system 130 to provide sensor system data 136 that may be used to determine one or more measurements, such as a trailer angle α. In some examples, the vehicle 102 may be autonomous or semi-autonomous, therefore, the sensor system 130 provides sensor data 136 for reliable and robust autonomous or semi-autonomous driving. The sensor system 130 provides sensor system data 136 and may include different types of sensors that may be used separately or with one another to create a perception of the tow vehicle's environment or a portion thereof that is used by the vehicle-trailer system 100 to identify object(s) in its environment and/or in some examples autonomously drive and make intelligent decisions based on objects and obstacles detected by the sensor system 130. In some examples, the sensor system 130 includes one or more sensors 132 supported by a rear portion of the tow vehicle 102 which provide sensor system data 136 associated with object(s) positioned behind the tow vehicle 102. The tow vehicle 102 may support the sensor system 130; while in other examples, the sensor system 130 is supported by the vehicle 102 and the trailer 104.

The sensor system 130 includes one or more cameras 132 that provide image sensor data 133. FIGS. 1A and 1B illustrate rearwardly-facing cameras 132a-d disposed along the tow vehicle 102 for sensing objects rearwardly thereof. Camera 132a is disposed at the tailgate of the tow vehicle 102; camera 132b is disposed at the driver-side mirror; camera 132c is disposed along the passenger-side mirror; and camera 132d is disposed at or near the CHMSL of the tow vehicle. It is understood that the number and location of the radar sensors 132 may vary relative to the tow vehicle 102. In some examples, each camera 132 may include a fisheye lens that includes an ultra wide-angle lens that produces strong visual distortion intended to create a wide panoramic or hemispherical image 135. Fisheye cameras capture image data 133 having an extremely wide angle of view. Other types of cameras may also be used to capture images 133 of the vehicle and trailer environment. The camera data 133 may include additional data 135 such as intrinsic parameters (e.g., focal length, image sensor format, and principal point) and extrinsic parameters (e.g., the coordinate system transformations from 3D vehicle coordinates to 3D camera coordinates, in other words, the extrinsic parameters define the position of the camera center and the heading of the camera in vehicle coordinates). In addition, the camera data 133 may include minimum/maximum/average height of each camera 132 with respect to ground (e.g., when the vehicle is loaded and unloaded), and a longitudinal distance between the camera 132 and the tow vehicle hitch ball.

Further, sensors 134 of the sensor system 130 may include, but is not limited to, radar, sonar, LIDAR (Light Detection and Ranging, which can entail optical remote sensing that measures properties of scattered light to find range and/or other information of a distant target), LADAR (Laser Detection and Ranging), ultrasonic, etc. The sensor system 130 provides sensor system data 136 that includes radar sensor data 133 from the one or more radar sensors 132 and sensor information 135 from the one or more other sensors 134. Therefore, the sensor system 130 is especially useful for receiving information of the environment or portion of the environment of the vehicle and for increasing safety in the vehicle-trailer system 100 which may operate by the driver or under semi-autonomous or autonomous conditions.

The tow vehicle 102 may include a user interface 140, such as a display. The user interface 140 is configured to display information to the driver of the tow vehicle 102. In some examples, the user interface 140 is configured to receive one or more user commands from the driver via one or more input mechanisms or a touch screen display and/or displays one or more notifications to the driver. In some examples, the user interface 140 is a touch screen display. In other examples, the user interface 140 is not a touchscreen and the driver may use an input device, such as, but not limited to, a rotary knob or a mouse to make a selection. In some examples, a trailer parameter detection system 160 instructs the user interface 140 to display one or more trailer parameters 162.

The user interface 140 is in communication with a vehicle controller 150 that includes a computing device or data processing hardware 152 (e.g., a central processing unit having one or more computing processors or microprocessors) in communication with non-transitory memory and/or memory hardware 154 (e.g., a hard disk, flash memory, random-access memory) capable of storing instructions executable on the computing processor(s)). In some examples, the non-transitory memory 154 stores instructions that when executed on the data processing hardware 152 cause the vehicle controller 150 to send a signal to one or more other vehicle systems. As shown, the vehicle controller 150 is supported by the tow vehicle 102; however, the vehicle controller 150 may be separate from the tow vehicle 102 and in communication with the tow vehicle 102 via a network (not shown). In addition, the vehicle controller 150 is in communication with the sensor system 130 and receives sensor system data 136 from the sensor system 130. In some examples, the vehicle controller 150 is configured to process sensor system data 136 received from the sensor system 130.

In some implementations, the vehicle controller 150 executes a trailer dimension calculation system 160 that is configured to identify and determine a dimension of the trailer 104 that is attached to the tow vehicle 102 using, in one example embodiment, cameras 132a-c and optionally camera 132d and sensors 134. The trailer dimension calculating system 160 may be part of and/or used with, for example, a trailer forward/reverse assist system of the tow vehicle 102. The trailer dimension calculating algorithm 162 of the trailer dimension calculating system 160, when executed by the vehicle controller 150, configures the vehicle controller to calculate at least one physical dimension of the trailer 104. The trailer dimension calculating system 160 may also calculates the trailer angle α of the vehicle-trailer system. The calculated trailer angle α may be used, for example, in a jack-knife detection operation of a trailer reverse assist function when the tow vehicle 102 and the trailer 104 are travelling in reverse.

The trailer dimension calculating system 160 and/or the trailer dimension calculating algorithm 162 thereof includes a number of blocks or modules for use in performing the trailer tracking and trailer angle calculation. Referring to FIG. 2, the trailer dimension calculating algorithm 162 includes image data preprocessor 166 which performs preprocessing on the image data received by cameras 132; camera selector 168 which, based upon the image data received from each of the cameras 132, selects a camera(s) 132 whose captured image data will be utilized by the trailer dimension calculation system 160, 162; feature detector 170 which identifies a feature of a trailer representation appearing in the image data 133 of the selected camera 132; feature distance estimator 172 which determines a distance of the identified feature; and trailer dimension estimator 174 which estimates a trailer dimension based upon the determined feature distance. A trailer angle estimator 176 determines the trailer angle formed between a longitudinal axis of the tow vehicle 102 and the longitudinal axis of the trailer 104.

### Image Data Preprocessor 166

In at least one implementation, the image data preprocessor 166 performs image enhancement using well-known techniques such as by applying smooth filters to reduce image noise. In addition, the preprocessor 166 also estimates a region of interest based on previous detections or utilizes a default detection in the absence of a prior region of interest. Optionally, one or more edge detection techniques, such as Canny edge detection, is used to highlight the contours of the trailer 104.

### Camera Selector 168

The camera selector 168 selects the camera 132 or cameras 132 to use in determining one or more dimensions of trailer 104 based upon an initial scan (i.e., initial images) of each camera 132. The intent is to identify the particular camera(s) 132 from all of the cameras 132 which are positioned to best determine one or more trailer dimensions. For example, a camera(s) 132 that best captures the front face of the trailer 104 is selected, such as camera 132a and/or 132d for use in determining trailer width. In a first implementation, the initial scan/images from cameras 132 are used to calculate a trailer angle formed between a center-positioned longitudinal axis of the tow vehicle 102 and a center-positioned longitudinal axis of the trailer 104 (hereinafter “the trailer angle”). An image from each camera 132 may be used to determine the trailer angle. Object recognition techniques such as edge detection, deep learning-based segmentation, or template matching may be utilized to identify the trailer 104 in the images. Based upon the calculated trailer angle, the camera(s) 132 is/are selected for determining the dimension(s) of the trailer 104. For example, the camera selector 168 may select rear-facing cameras 132a or 132d for trailer angles within approximately ±60 degrees relative to the vehicle's centerline. For trailer angles exceeding ±60 degrees, side-view cameras 132b or 132c may be prioritized to better capture relevant trailer features. Angles other than 60 degrees, such as 30 degrees, 40 degrees, 50 degrees, and any other suitable angle, may be used as a threshold for switching between using a tailgate and/or CHMSL-based camera, on the one hand, and a side-view-mirror-mounted camera, on the other hand.

In a second implementation, the camera selector 168 selects the camera(s) 132 based on a determined confidence metric. The confidence metric may be determined based upon the area, in pixels, of the representation of the trailer 104 in the images. For example, the camera 132 whose image has the largest area of the trailer representation may be selected. A trailer representation of a complete trailer 104 that occupies the largest area in an image, for example, may be used to select the camera 132 for determining trailer length.

It is understood that more than one camera 132 may be selected in combination based upon the calculated trailer angle or confidence metric for determining a trailer dimension. It is further understood that different cameras 132 may be selected based upon the particular dimension (e.g., length, width, and/or height) of trailer 104 that is desired. Images from the camera 132 for determining trailer length may be different from the camera 132 for determining trailer width, for example.

### Feature Detector 170

Once one or more cameras 132 are selected, images from the selected one or more cameras are used by the feature detector 170 identifies a specific feature of the trailer (e.g., rear axle, top edge), and the feature distance estimator 172 computes the spatial distance between features in 3D space. The feature detection may be within the region of interest identified by the image data processor 166.

In order to determine trailer length, which is defined as the distance from the hitch point of the trailer 104 to the rear end thereof, the rear axle detection may employ Hough Transform to identify circular shapes such as wheels and tires of the trailer 104, or use predefined patterns matched via machine learning algorithms, or other predefined patterns corresponding to features of the rear axle. Machine learning or deep learning may be utilized in a neural network for detecting a rear axle feature. Further, known edge detection and contour detection techniques may be utilized to detect the rear end of the trailer 104. The technique for detecting the edge or contour which defines the rear end of the trailer 104 may use any known shape analysis or contour approximation and may utilize machine learning or deep learning to carry out the analysis/approximation.

In order to determine trailer height, the top and bottom edges of the trailer representation may be detected. Image analysis techniques may be utilized such as the Hough Transform to detect horizontal straight-line shapes or predefined patterns that are dependent upon the particular trailer 104.

Determining trailer width may include detecting the leftmost and right most edges of the trailer representation in the image(s). Image analysis techniques may be utilized such as the Hough Transform to detect leftmost and rightmost vertical straight-line shapes or predefined patterns that are dependent upon the particular trailer 104.

### Feature Distance Estimator 172

The feature distance calculator 172 estimates the distances and/or measurements associated with the features detected by the feature detector 170. In the event a single monocular camera 132 is selected by the camera selector 168, a sequence of images from the camera may be used, and optionally additional sensor data (e.g., vehicle speed, kinematics and steering angle) may be utilized. The feature distance estimator 172 computes a three-dimensional (3D) reconstruction of the trailer. In this context, a 3D reconstruction refers to generating a spatial point cloud composed of features detected by the feature detector 170. This point cloud includes at least two distinct boundary points on either the front or side face of the trailer, enabling accurate estimation of the trailer's width or length, respectively. The 3D reconstruction may be up to an unknown scale, assuming a single monocular camera 132 being used. To recover scale and provide accurate distance information, the feature detector 170 may use stereo imaging/vision for points or shapes that are found in images from more than one camera 132, such as the tailgate camera 132a along with a side camera 132b or 132c. In addition, or in the alternative, the feature distance estimator 172 may utilize known size and perspective cues to estimate the scale of the trailer representation. For example, the known diameter of trailer wheels (e.g., 16-20 inches) may be used as a reference length. In such a case, circular features corresponding to wheels are detected in the image using contour analysis or shape-based detection (e.g., Hough Transform), and the known wheel size is used to convert pixel distances to real-world units. Similarly, the spacing between tandem axles, when detected, may serve as a baseline for scaling 3D measurements of the trailer. The distance between the camera and the trailer hitch (which is a known, fixed parameter from vehicle calibration) may also serve as a reference to anchor subsequent distance calculations. The trailer width may additionally be used as a known or assumed dimension to infer other dimensional estimates when the trailer type is known or selected from a predefined class.

Moreover, the feature distance estimator 172 may apply Structure from Motion (SfM) or Simultaneous Localization and Mapping (SLAM) to generate a scaled or unscaled 3D model of the trailer. To resolve scale ambiguity in monocular reconstructions, the estimator may fuse in vehicle dynamics data or use matched features from multiple viewpoints across time (temporal parallax). In more advanced implementations, Neural Radiance Fields (NeRFs) or learned depth networks may be used to generate spatially accurate trailer geometry. In some embodiments, trailer dimensions may also be inferred based on metadata retrieved from the vehicle's CAN network, such as trailer type, wheelbase, or connection configuration (e.g., fifth-wheel, gooseneck), which are used either as hard-coded parameters or as validation thresholds for visual estimates.

Accordingly, the feature distance estimator 172 may utilize any of a number of known algorithms and scaling cues to perform 3D reconstruction and distance estimation, including but not limited to edge detection, triangulation, known dimension matching, stereo vision, Structure from Motion (SfM), Simultaneous Localization and Mapping (SLAM), or Neural Radiance Fields (NeRF).

### Trailer Dimension Estimator

The trailer dimension estimator 172 provides one or more trailer dimensions based upon the detected trailer features and their corresponding determined distances. For trailer length estimation, a combination of multiple measurements may be used. In one implementation, the estimated wheelbase length of the trailer defined as the distance from the hitch point to the rear axle may be provided by the tow vehicle operator via the user interface 140 or inferred from recognized trailer classes. This wheelbase length is then added to the measured distance from the rear axle to the rear end of the trailer 104, as detected by the feature detector 170 and calculated by the feature distance estimator 172. The resulting value represents the overall trailer length. In other implementations, where the rear axle or wheels are not visible, the trailer length may instead be derived directly by estimating the distance between the detected hitch point and the rear edge or corner of the trailer 104.

To achieve real-world scaling, the system may use reference measurements such as the known diameter of the trailer wheels, spacing between tandem axles, or the calibrated distance between the tow vehicle's camera and hitch ball. When such features are detected in the image, and their real-world sizes are known or assumed from a database of trailer types, the estimator 172 converts point cloud measurements to metric dimensions. In stereo configurations, where images are captured from two or more cameras with known relative positions (e.g., 132a and 132b), stereo triangulation may be used to derive depth estimates directly, removing the need for external scaling.

For trailer width estimation, the trailer dimension estimator 172 uses the detected leftmost and rightmost vertical edges or corners of the trailer's representation in the image(s), as provided by the feature detector 170. These edges are typically determined using techniques such as the Hough Transform for line detection, contour analysis, or machine-learning-based segmentation methods. The pixel distance between the vertical edges is converted to a real-world width using scale derived from reference features such as the known trailer height or from stereo depth cues when multiple camera views are available.

Similarly, the trailer height is calculated using the real-world distance between the topmost and bottommost horizontal edges or corners of the trailer representation. The edges may be detected using line or shape detection algorithms or deep learning models trained to identify trailer boundaries. The estimator 172 then computes the vertical distance between these edges in the image and scales it based on known cues such as wheel size, camera height from ground, or previously computed trailer width. When multiple features are visible in the scene, the estimator may cross-check dimensional consistency to increase reliability.

In some embodiments, the trailer dimension estimator 172 may leverage historical trailer data, manufacturer specifications, or machine-learned trailer templates to validate or refine the calculated dimensions. If a trailer type is identified from sensor data, user input, or a connected trailer metadata (e.g., via the vehicle's CAN network), pre-stored dimension ranges for that trailer type may be used to inform or bound the estimation process. This approach enhances robustness under occlusion, poor lighting, or low-contrast conditions.

### Trailer Angle Estimator

The trailer angle estimator 176 determines the trailer angle between the tow vehicle 102 and the trailer 104. A SLAM-based algorithm may be used in part by estimating the pose of the trailer 104 relative to the selected camera(s) 132. Alternatively, any of a number of known algorithms for determining the trailer angle may be used.

### Operation

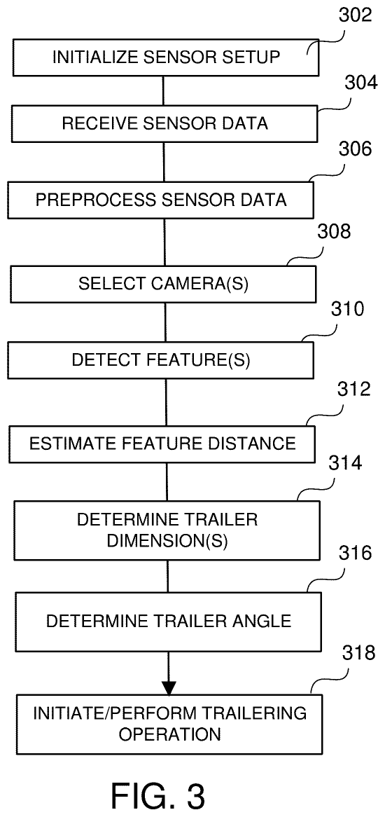

FIG. 3 is a flowchart illustrating the operation of the trailer dimension calculator 160, 162 according to an example embodiment. Following activation of the trailer dimension calculator 160, 162, which may occur following vehicle/engine start or when the connected trailer 104 is detected, the sensors of sensor system 130, including cameras 132, are initialized at 302. Sensor data 136 is received by the controller 150 at 304. The sensor data is preprocessed to reduce image noise and a region of interest is estimated, as described above. From an initial scan and/or initial image data from each of the cameras 132, at least one camera 132 is selected at 308 as described above for use in determining one or more particular trailer dimensions. Features of the representation of the tow vehicle 104 are detected in the image data from the selected camera(s) 132 at 310, as described above. The feature distances associated with the detected features are estimated at 312, as described above. Using the detected features and their corresponding estimated distances, one or more trailer dimensions are determined at 314, as described above. The trailer angle is determined at 316, as described above. The determined trailer dimensions and/or the trailer angle are provided to a trailer assist system of the tow vehicle 102 at 318 for use in performing a trailer-related operation(s), which initiates performance of the trailer-related operation(s) based on the determined trailer dimension and/or trailer angle. The trailer assist system carries out the trailer-related operation(s).

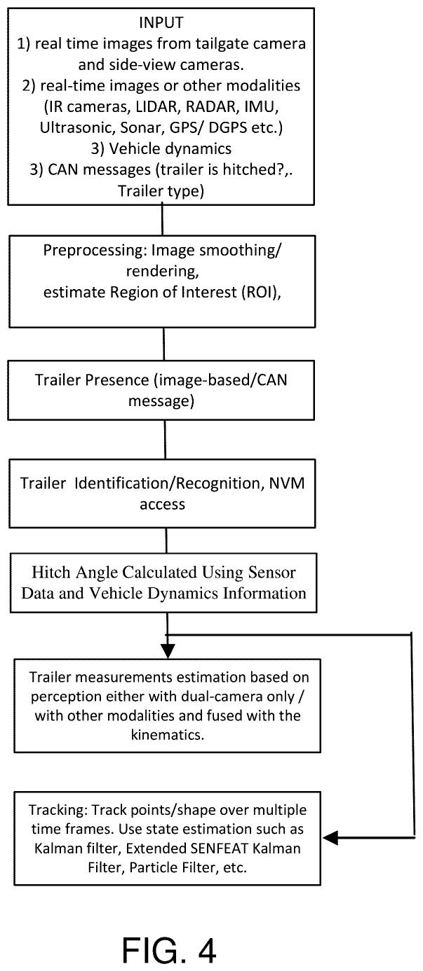

FIG. 4 illustrates a trailering operation that utilizes the trailer dimension determinations, according to an example embodiment. Image/sensor data is provided to the vehicle controller 150 and preprocessed, as described above. The trailer is detected in the sensor data. The trailer angle is determined using sensor data and vehicle dynamics information, and trailer dimensions are determined. Thereafter, a trailer-related assist operation is performed, which in this case includes tracking trailer points and/or shapes over multiple time frames.

Machine learning and/or deep learning may be utilized for performing one or more of the blocks/algorithms 166-176 described above. Machine and deep learning implementations are able to learn complex representation of imaging data (e.g., point cloud data) with noise and clutter, and provide models for a number of different trailer types. Machine and deep learning maintain data integrity while processing by extracting relevant features directly from the imaging (point cloud) data. Machine/deep learning is a data-based approach and can generalize over varying scenarios and weather conditions, which in turn can provide higher accuracy of detection and distance determinations as the generated trailer models use a non-linear approach. Trailer models generated by trained machine and deep learning networks can be easily scaled to incorporate other sensor modalities to combine data for improved detection and accuracy, which in turn can support trailer systems that can work in L2-L4 autonomous vehicles.

Feature detection methods described above may include a machine learning based implementation, such as 1) using feature engineering such as support vector machines (SVMs), a Random Forest Classifier, etc. The machine learning based implementation may be shape-based such as using the Hough Transform, random sample consensus (RANSAC), etc. In addition or in the alternative, point cloud clustering-based implementations may be used, such as K-means clustering, Pointnet, Pointnet++, a graph neural network (GNN), a 3D convolutional neural network (CNN), binary segmentation (e.g., U-Net, mask region-based CNN, transformers, etc.).

To the extent feature tracking is utilized, such tracking may use a Kalman filter, extended Kalman filter or a particle filter. A temporal-based approach may be utilized, such as long short-term memory (LTSM), DeepSORT or the like which rely on different frames for object association. A GNN, a graph convolutional network (GCN) and/or transformers may also be used for feature detection and tracking.

The present disclosure pertains to products and projects related to automotive and commercial vehicles, specifically those have towing systems and trailer control/management safety features. It is designed for use by OEMs and automotive technology companies focused on integrating advanced driver assistance systems. Also, it is designed for customers who frequently use trailers such conventional, Gooseneck, 5^{th} wheel including commercial trailers.

In accordance with one or more embodiments, trailer recognition may be improved by integrating dimensions saved during a previous ignition cycle, when a predetermined set of dimension estimates match a trailer that has been previously saved by the tow vehicle. For example, when 80%, 90%, or some other suitable percentage of dimensions saved during a previous ignition cycle, match current estimated trailer dimensions, the dimensions saved during the previous ignition cycle may be used in estimating trailer dimensions, such as length, width, and/or height.

The present disclosure addresses three main shortcomings related to trailer usage with cars/trucks such as trailer reverse, trailer hitch, forward driving:
1. Provides accurate measurement of trailer features such as wheelbase, hitch angle, length, width, and height, which are critical for safe and efficient towing;
2. Enhanced safety by more accurately detecting trailer dimensions, under conditions involving higher trailer angles (e.g., >60 degrees), and providing the accurately detected trailer dimensions to the control system improving overall vehicle stability and handling, reducing the risk of accidents caused by poor maneuvering or jackknife occurrences thereby improving trailer-assist operations including, but not limited to, autonomous trailer parking, lane-change assist with trailer, collision avoidance, and the like; and
3. Improved towing efficiency, especially for drivers who have relatively little experience in maneuvering a tow vehicle and trailer, since the driver can make better decisions using all visual information provided by the sensing system.

Image processing algorithms discussed herein process and analyze the captured images to detect the presence of hitched trailer. Additionally, the trailer brake connection can provide a CAN input for confirmation of trailer being connected. Information from the vision-based presence and CAN presence could be combined or only one of the inputs used. If trailer connected to the tow vehicle exists, the trailer is identified and key trailer measurements estimated such as wheelbase, hitch angle, length, width, and height, etc.

The vision-based system uses a combination of computer vision, machine learning and deep learning techniques to detect and outline the trailer's structure, identifying specific reference points/shape needed to estimate trailer measurements.

The vision-based system dynamically switches between two camera views, selecting the one that offers the best perspective for accurate detection and image processing.

Higher Angle Estimation: The system compensates when one camera's field of view (FOV) is limited, ensuring accurate angle estimation. This modular architecture allows for the use of different types of cameras with varying FOVs to meet specific requirements.

Improved accuracy: using two or more cameras from different angles enhances the accuracy and stability of trailer dimension measurements. The tailgate camera captures a better view of the trailer's surface at near-zero hitch angles, supporting trailer recognition and presence functions. Meanwhile, the CHMSL camera or the two side mirror cameras provide a better view of the trailer at hitch angles greater than 30 degrees, improving angle estimation at higher angles and offering better height and width detection. This multi-camera setup ensures accurate and reliable measurements across a wide range of hitch angles.

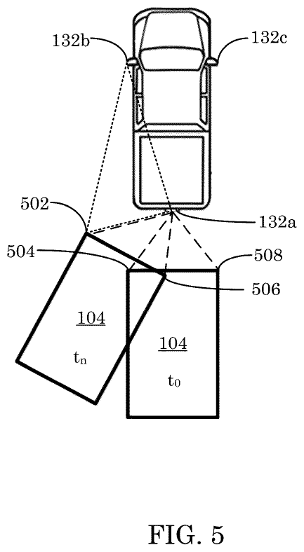

FIG. 5 is a schematic view depicting stereo triangulation, by a tailgate camera and a side-view camera, of a corner of a trailer in accordance with one or more embodiments of the invention. Monocular reconstruction is performed using the tailgate (rear) camera 132a, tracking the left and right edge corners (504 and 508 at time t₀ and 502 and 506 at time tₙ) of the trailer's front face across frames from t₀ to tₙ. This step relies on relative motion within the tailgate camera's field of view so side cameras are not involved. Stereo triangulation of the corner 502 at time tₙ of trailer 104 is performed by the side-view camera 132b and the tailgate camera 132a.

A method of stereo triangulation for determining trailer length, width, and height estimation, in accordance with one or more embodiments of the invention will be described. Assumptions include:
1. Trailer has a single articulation point at the hitch.
2. Front face of the trailer is available for most frames with the rear (e.g., tailgate) camera.
3. Rear or side view may not be fully visible in the rear camera Field of View (FOV).
4. The trailer is rigid.
5. The rear and side cameras are calibrated (i.e., camera extrinsic and intrinsic parameters are known).
6. Structure From Motion (SFM), Simultaneous Localization and Mapping (SLAM), Visual Odometry (VO) are known concepts so steps of calculating essential matrix, triangulation, bundle adjustment, and the like are not described in detail.
7. For width and height estimation, at higher hitch angles at least a single trailer's feature is visible in one of the side cameras FOV and the rear camera FOV (e.g. front corner, side panel, rear corner/wheel). As mentioned previously, higher hitch angles could be 30 degrees, 60 degrees, or some other suitable angle. Being able to see the full length of the side of the trailer is more important than any particular threshold angle. While using a tailgate camera, at a trailer angle of approximately 50-60 degrees, the tailgate camera starts losing view of the trailer. So, it becomes hard to estimate the trailer angle. Side-view cameras provide a significant advantage under such circumstances.
8. For length estimation, at higher hitch angles the trailer's full side profile is visible in one of the side cameras FOV (e.g. front corner, side panel, rear corner/wheel).

For estimating width and height:
1. Feature Extraction and Reconstruction
   From the rear camera, isolate trailer-specific features using semantic segmentation. Then, using monocular SfM, SLAM, and VO, estimate the relative motion between the trailer and the vehicle to generate a point cloud or a 2D/3D reconstruction of the trailer.
2. Scale Ambiguity
   Since the reconstruction is based on a monocular camera, the resulting model is up to an unknown scale.
3. Scale Recovery via Stereo Triangulation
   Identify a common trailer feature (e.g., a blob, corner, keypoint, etc.) visible in both the rear and side cameras.
      Use stereo triangulation to compute the 3D coordinates of this feature. This gives the distance from this trailer's feature to each camera.
      Match this feature to a corresponding feature in the monocular reconstruction given in Step 1 to recover the absolute scale of the model.
4. Dimension Estimation
   With the scale recovered, compute the width and height of the trailer from the scaled 3D reconstruction.

For estimating trailer length: like the width and height estimation, the trailer's length is calculated using a monocular 2D/3D reconstruction derived from the side camera. Techniques such as SfM,), and VO are used to build this reconstruction.

Since the reconstruction from a monocular camera is up to an unknown scale, we recover the absolute scale using stereo vision:
1. Identify a Common Feature
   Select a distinctive trailer feature (e.g., a corner, bolt, marker, etc.) that is visible in one of side camera and one of the rear cameras.
2. Stereo Triangulation
   Use stereo vision to triangulate the 3D coordinates of this common feature, calculating its distance from both cameras.
3. Scale Recovery
   Match this feature to its corresponding point in the monocular 2D/3D reconstruction. Using the known distance and the relative position in the reconstruction, compute the scale factor as a ratio of the calculated distances.
4. Length Estimation
   Apply the recovered scale to the reconstructed trailer model to estimate the length of the trailer.
5. Refine with Filtering
   Use an Extended Kalman Filter (EKF) or smoothing filter to:
   Fuse:
      Image-based trailer length.
      Kinematic estimate.
      Any 2D/3D estimates from SfM/SLAM/VO.

A method of using flat road assumption for determining trailer length, width, and height estimation, in accordance with one or more embodiments of the invention will be described.

### Overview:

### Assumptions:

1. Trailer has a single articulation point at the hitch.
2. Front face of the trailer is available for most frames with the rear (e.g., tailgate) camera.
3. Rear or side view may not be fully visible in the rear camera Field of View (FOV).
4. The trailer is rigid.
5. The rear and side cameras are calibrated (i.e., camera extrinsic and intrinsic parameters are known).
6. SFM, SLAM, VO are known concepts so steps of calculating essential matrix, triangulation, bundle adjustment, etc. are not described.
7. For width and height estimation, at higher hitch angles at least a single trailer's feature is visible in one of the side cameras FOV and the rear camera FOV (e.g. front corner, side panel, rear corner/wheel).
8. For length estimation, at higher hitch angles the trailer's full side profile is visible in one of the side cameras FOV (e.g. front corner, side panel, rear corner/wheel).
9. The vehicle trailer system is in a flat ground plane.

Steps of the method include:
1. For selected cameras, perform a 2D/3D monocular reconstruction, which can be done by SfM/SLAM/VO. The monocular 2D/3D reconstruction uses trailer and road features (lane marking, texture, pod holes, cracks, etc.). The outputs of this step are:
   a. 2D/3D trailer reconstruction.
   b. Road plane estimation.
2. Recover scale of the 2D/3D reconstruction using the distance from camera to the flat road.
3. For width estimation, use the rear camera 2D/3D reconstruction.
4. For height estimation, either use the rear or side camera 2D/3D reconstruction.
5. For length estimation, use one of the side cameras 2D/3D reconstruction.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, model-based design with auto-code generation, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for visual trailer tracking for vehicle-trailer angle estimation, the method comprising:
receiving, by data processing hardware, image data from a plurality of cameras that are positioned on a tow vehicle and rearwardly facing to capture a rearward environment of the tow vehicle that includes a connected trailer;
detecting, by the data processing hardware, a representation of the trailer in the received image data from each of the cameras;
based upon the trailer representation in the image data from each camera, selecting, by the data processing hardware, at least one camera from the plurality of cameras;
detecting, by the data processing hardware, a feature of the trailer representation and a location of the trailer representation feature in the image data from the selected at least one camera;
estimating, by the data processing hardware, a distance associated with the detected feature of the trailer representation;
determining, by the data processing hardware, a trailer dimension based upon the estimated distance of the detected feature; and
initiating, by the data processing hardware, a trailer assist operation for the tow vehicle based upon the determined trailer dimension.

2. The method of claim 1, further comprising, for each camera, determining, by the data processing hardware using the image data from the camera, at least one of a trailer angle or a pixel area occupied by the trailer representation in the image data, the trailer angle comprising an angle formed between a longitudinal axis of the tow vehicle and a longitudinal axis of the trailer, wherein selecting the at least one camera is based upon the at least one of the trailer angle or the pixel area.

3. The method of claim 2, wherein selecting the at least one camera is based upon the trailer angle and the pixel area.

4. The method of claim 1, further comprising determining, by the data processing hardware, a trailer angle based on the trailer representation in the image data, the trailer angle comprising an angle formed between a longitudinal axis of the tow vehicle and a longitudinal axis of the trailer, wherein selecting the at least one camera is based upon the determined trailer angle.

5. The method of claim 1, wherein the feature of the trailer representation comprises an uppermost edge or corner of the trailer representation, and the trailer dimension comprises a height of the trailer that is determined based on the upper edge or corner of the trailer representation.

6. The method of claim 1, wherein the feature of the trailer representation comprises a leftmost vertical edge or corner and a rightmost vertical edge or corner of the trailer representation, and the trailer dimension comprises a width of the trailer that is determined based upon the leftmost and rightmost vertical edges or corners of the trailer representation.

7. The method of claim 1, wherein the feature of the trailer representation comprises at least one of a rear axle of the trailer representation, a rear end edge, or corner of the trailer representation, and trailer dimension comprises a trailer length that is determined based upon the at least one of the rear axle of the trailer representation, the rear end edge, or corner of the trailer representation.

8. A system for determining a dimension of a trailer that is connected to a tow vehicle, comprising:
memory hardware in communication with data processing hardware, the memory hardware storing instructions that when executed by the data processing hardware cause the data processing hardware to perform operations comprising:
receiving image data from a plurality of cameras positioned on a tow vehicle and rearwardly facing to capture a rearward environment of the tow vehicle that includes a connected trailer;
detecting a representation of the trailer in the received image data from each of the cameras;
based upon the trailer representation in the image data from each camera, selecting at least one camera from the plurality of cameras;
detecting a feature of the trailer representation and a location of the trailer representation feature in the image data from the selected at least one camera;
estimating a distance associated with the detected feature of the trailer representation;
determining a trailer dimension based upon the estimated distance of the detected feature; and
initiating a trailer assist operation for the tow vehicle based upon the determined trailer dimension.
